(19) United States
(12) Patent Application Publication
(10) Pub. No.: US 2008/0254993 A1
(43) Pub. Date: Oct. 16, 2008

(54) Use of abscisic acid analogs to enhance growth control

(76) Inventors: Xiaozhong Liu, Vernon Hills, IL (US); Peter D. Petracek, Grayslake, IL (US); Daniel F. Heiman, Libertyville, IL (US); Mark Beach, Kenosha, WI (US); Prem Warrior, Green Oaks, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/011,811

(22) Filed: Jan. 30, 2008

Related U.S. Application Data
(60) Provisional application No. 60/898,589, filed on Jan. 31, 2007.

(51) Int. Cl. A01N 37/06

(52) U.S. Cl. 504/317; 504/321

(57) ABSTRACT

This invention describes the use of analogs or derivatives of abscisic acid or their salts in combination with gibberellin biosynthesis inhibitors to improve the performance of gibberellin synthesis inhibitors, and to increase water conservation in plants such as turfgrass.

### FIELD OF THE INVENTION

The present invention is directed to improving the performance of gibberellin synthesis inhibitors by hastening growth control, providing additional growth control and extending the effective period of growth control and increasing water conservation by using combinations of gibberellin synthesis inhibitors and abscisic acid (ABA) analogs, ABA derivatives or their salts.

### BACKGROUND OF THE INVENTION

Abscisic acid (ABA) is a natural plant growth regulator that is responsible for stress tolerance. ABA causes stomatal closure (Assmann, S. 2004 In: Plant Hormones Biosynthesis, Signal Transduction, Action ed. P. J. Davies, p 391-412) and reduces water use. The stomatal closure caused by ABA can contribute to reductions of plant transpiration and thus increase drought and water conservation. ABA analogs also reduce water use (Sharma, N., S. R. Abrams and D. R. Waterer, 2005, J. Plant Growth Regul., 24: 28-35) although their precise role in stomatal closure is not fully understood. Although ABA (Petracek, P. D., D. Woolard, R. Menendez and P. Warrior, 2005, Proc. PGRSA, 32: 7-9) and ABA analogs (Sharma, N., S. R. Abrams and D. R. Waterer, 2005, J. Plant Growth Regul., 24: 28-35) have been shown to reduce plant growth, their effect on growth is less well understood.

Mowing is one of the major practices in turfgrass management. Plant growth retardants, which are turfgrass plant growth regulators (PGRs), have been widely used by the turfgrass industry to suppress growth and thus to reduce mowing frequency and clippings. Turfgrass PGRs can also be used to reduce scalping and increase ball roll speed. As a result, turfgrass PGRs can reduce costs for golf courses, sport stadiums and roadside turfgrass management by reducing costs for labor, equipment and fuel.

Several PGRs are currently used by the turfgrass industry. Mefluidide®, Embark Plant Growth Regulator, is a product of PBI/Gordon Corporation (Kansas City, Mo.) that was developed in the later 1970s. Mefluidide® is a PGR that is absorbed by leaves and slows cell division. Flurprimidol®, Cutless, is a product of SePRO Corporation (Carmel, Ind.) that was commercialized in the 1980s. Paclobutrazol®, Trimmit 2SC, is a product of Syngenta Crop Protection Inc. (Greensboro, N.C.) that was also commercialized in the 1980s by The Scotts Company (Marysville, Ohio) with the trade name of TGR Turfgrass Enhancer. Both flurprimidol and paclobutrazol are root absorbed and inhibit the formation of gibberellins during the early stages of the biosynthesis pathway. Trinexapac-ethyl is another product of Syngenta Crop Protection Inc. (Greensboro, N.C.) with trade name of Primo Maxx® that was developed in the 1990s. Trinexapac-ethyl is absorbed by leaves and inhibits the conversion of GA₂₀ to GA₁.

There are several problems associated with commercial turfgrass PGR products. Phytotoxicity is a major factor limiting turfgrass PGRs application, especially in fine turfgrass. Leaf yellowing and damage usually happen after the application of Embark, Cutless or Trimmit. Primo Maxx® was the first PGR to suppress growth as well as improve turfgrass quality (Dennis Shepard, Turfgrass Trends. April 2002). However, leaf yellowing occurs in the initial state after application. Phytotoxicity can be alleviated by reducing application rate and increasing application frequency. However, this practice increases the labor and equipment cost of PGR application.

A second problem is the different reaction among turfgrass species to PGRs. The effect of PGRs on turfgrass varies with species, varieties and mowing height (see label of each product). Primo Maxx® is an effective PGR that inhibits almost all the major turfgrass species. However, the rate required to inhibit growth varies in different turfgrass species and with mowing height. When several species or varieties are planted in the same area, this characteristic may cause a decline in the uniformity of turfgrass and thus a decline of turfgrass quality.

Finally, continuous application of turfgrass PGRs may cause abnormalities of physiological metabolism due to the deficiency of gibberellin in plants. Turfgrass that received frequent treatment with gibberellin synthesis inhibitors showed low quality and was susceptible to stresses.

Thus, there is a need to provide a more effective method of turfgrass control that provides faster growth inhibition, provides more growth inhibition, extends the duration of the growth inhibitory effect of gibberellin synthesis inhibitors and increases water conservation with respect to turfgrass.

### SUMMARY OF THE INVENTION

The present invention is directed to the treatment of turfgrass with combinations of gibberellin biosynthesis inhibitors (gibberellin synthesis inhibitors) and ABA derivatives, analogs or their salts. This treatment accelerates growth inhibition, provides additional growth inhibition and extends the duration of growth inhibitory effect of gibberellin synthesis inhibitors. The combination of gibberellin synthesis inhibitors with ABA analogs also decreases evaportranspiration rate and thus reduces water use amount.

Cool season species, such as creeping bentgrass, Kentucky bluegrass and tall fescue, show significant and long lasting growth inhibitory effects to the combinations of gibberellin synthesis inhibitors and ABA derivatives or analogs. However, warm season grasses such as Bermudagrass are not as sensitive as cool season grasses to the combination of gibberellin synthesis inhibitors and ABA derivatives or analogs.

The present invention provides additional benefit compared to PGRs in the current turfgrass market. This invention can be used to enhance gibberellin synthesis inhibitors by producing new formulations or tank mixing ABA derivatives or analogs with current commercial turfgrass PGRs to inhibit turfgrass growth as well as to reduce water use amount.

This invention can be used to enhance growth control and water use in other monocotyledonous plants as well as dicotyledonous plants.

### DETAILED DESCRIPTION OF THE INVENTION

The present invention inhibits growth of, and decreases water use with, turfgrass. The treatment comprises applying an effective, but non-phytotoxic amount of the PGR abscisic acid (ABA, ABA) derivatives and/or ABA analogs or their salts in combination with gibberellin biosynthesis inhibitors

Presently preferred ABA analogs and derivatives include PBI-429, PBI-524, PBI-696 and PBI-702.

For the purposes of this Application, abscisic acid analogs are defined by Structures 1, 2 and 3, wherein for Structure 1:

the bond at the 2-position of the side chain is a cis- or trans-double bond,

the bond at the 4-position of the side chain is a trans-double bond or a triple bond,

the stereochemistry of the alcoholic hydroxyl group is S-, R- or an R,S-mixture,

the stereochemistry of the R1 group is in a cis-relationship to the alcoholic hydroxyl group,

R1=ethynyl, ethenyl, cyclopropyl or trifluoromethyl, and
R2=hydrogen or lower alkyl

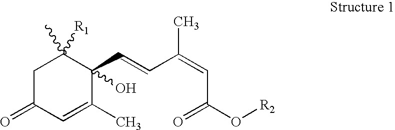

wherein lower alkyl is defined as an alkyl group containing 1 to 4 carbon atoms in a straight or branched chain, which may comprise zero or one ring or double bond when 3 or more carbon atoms are present.

For PBI-429, R1 is ethynyl and R2 is a methyl group.

For PBI-524, R1 is ethynyl and R2 is a hydrogen.

For PBI-696, R1 is cyclopropyl and R2 is a methyl group.

### For Structure 2:

the bond at the 2-position of the side chain is a cis- or trans-double bond,

the bond at the 4-position of the side chain is a triple bond,

the stereochemistry of the alcoholic hydroxyl group is S-, R- or an R,S-mixture,

R1=hydrogen or lower alkyl

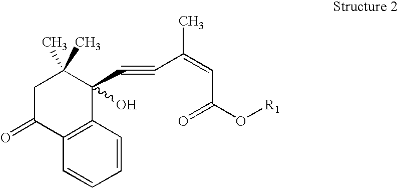

wherein lower alkyl is defined as an alkyl group containing 1 to 4 carbon atoms in a straight or branched chain, which may comprise zero or one ring or double bond when 3 or more carbon atoms are present.

For PBI-702, R1 is a methyl group.

### For Structure 3:

the bond at the 2-position of the side chain is a cis- or trans-double bond,

the bond at the 4-position of the side chain is a trans-double bond,

the stereochemistry of the alcoholic hydroxyl group is S-, R- or an R,S-mixture,

R1 hydrogen or lower alkyl

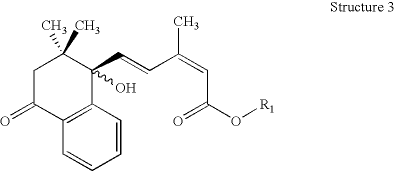

wherein lower alkyl is defined as an alkyl group containing 1 to 4 carbon atoms in a straight or branched chain, which may comprise zero or one ring or double bond when 3 or more carbon atoms are present.

It is also contemplated that salts of the ABA analogs set forth above may be utilized in accordance with the present invention.

As used herein, the term “salt” refers to the water soluble salts of ABA or ABA analogs or derivatives, as appropriate. Representative such salts include inorganic salts such as the ammonium, lithium, sodium, potassium, calcium and magnesium salts and organic amine salts such as the triethanolamine, dimethylethanolamine and ethanolamine salts.

Gibberellin biosynthesis inhibitors useful in the present invention include, but are not limited to, trinexapac-ethyl, paclobutrazol, uniconazole-P, chlormequat-Cl, mepiquat-Cl, AMO-1618, tetcyclacis, ancymidol, flurprimidol, prohexadione-Ca, daminozide, 16,17-Dihydro Gas, and chlorpropham.

Surfactants can be added to the gibberellin biosynthesis inhibitor/ABA derivative or analog solution to improve the performance of the PGRs.

The presently preferred surfactant for ABA performance is Brij 98 (polyoxyethylene (20) oleyl ether) available from Uniqema (Castle, Del.). Other surfactants are also useful in the present invention, including but not limited to, other surfactants in the Brij family (polyoxyethylene fatty alcohol ether) from Uniqema (Castle, Del.), the Tween family (Polyoxyethylene sorbitan esters) from Uniqema (Castle, Del.), Silwet family (Organosilicone) from GE Silicones (Wilton, Conn.), the Triton family (Octylphenol ethoxylate) from The Dow Chemical Company (Midland, Mich.), the Tomadol family (ethoxylated linear alcohol) from Tomah3 Products, Inc. (Milton, Wis.), the Myrj family (Polyoxyethylene (POE) fatty acid esters) from Uniqema (Castle, Del.), the Span family (Sorbitan ester) from Uniqema (Castle, Del.), and the Trylox family (Ethoxylated Sorbitol and Ethoxylated Sorbitol Esters) from Cognis Corporation (Cincinnati, Ohio) as well as commercial surfactant Latron B-1956 (77.0% modified phthalic/glycerol alkyl resin and 23.0% Butyl alcohol) from Rohm & Haas (Philadelphia, Pa.), Capsil (Blend of Polyether-polymethylsiloxanecopolymer and nonionic surfactant) from Aquatrols (Paulsboro, N.J.), Agral 90 (Nonyl phenol ethoxylate) from Norac Concept. Inc. (Orleans, Ontario, Canada), Kinetic (99.00% Proprietary blend of polyalkyleneoxide modified polydimethylsiloxane and nonionic surfactants) from Setre Chemical Company (Memphis, Tenn.), and Regulaid (90.6% 2-butoxyethanol, poloxalene, monopropylene glycol) from KALO, Inc. (Overland Park, Kans.).

Other additives that can be added to the gibberellin biosynthesis inhibitor/ABA derivative or analog combination include, but are not limited to, urea, nitrate salts such as ammonium nitrate, humectants such as poly(ethylene glycol) and vegetable oils such as soybean oil, corn oil, cotton oil and palm oil.

This combination of ABA analogs or derivatives and gibberellin synthesis inhibitors can be used as a formulated liquid or solid product or as a tank mix. This combination was found to be particularly effective on cool season grasses, other turfgrass species and other plant species are expected to respond similarly. Also, while only one gibberellin synthesis inhibitor was tested (trinexapac-ethyl), other gibberellin synthesis inhibitors are also expected to be effective for the same use.

While the target plants are cool-season turfgrass, other plant species such as bedding plants or vegetable seedlings may also show similar effects.

Depending on the species of turfgrass, mowing height, environmental conditions and chemical characteristics of the ABA analogs, the applied concentration of the ABA analogs can vary within wide ranges and is generally in the range of about 0.1 ppm to about 2000 ppm, preferably from about 1 to about 1000 ppm.

Depending on the species of turfgrass, mowing height, environmental conditions, and chemical characteristics of the Gibberellin synthesis inhibitors, the applied concentration of the gibberellin synthesis inhibitors can vary within wide ranges and is generally in the range of about 0.1 ppm to about 10,000 ppm, preferably from about 1 ppm to about 1000 ppm.

The water solution may also contain between about 0.01% to about 0.5% v/v surfactants such as Tween 20 (Sigma-Aldrich, St. Louis, Mo.). Water is used as the carrier solvent.

The effective concentration range of active ingredients may vary depending on the water volume applied to grasses as well as other factors such the plant height, age of the grass and the requirements of duration of growth inhibition and quality.

The concentration ranges of the ABA derivatives or analogs alone or the combinations of ABA derivatives or analogs with gibberellin synthesis inhibitor include in principle any concentration range useful for inhibiting turfgrass growth and reducing water use.

The invention can be illustrated by following representative examples.

### EXAMPLES

Greenhouse studies were conducted at the Research Farm of Valent BioSciences Corporation (Long Grove, Ill.). Grasses were grown in pots (18 cm in diameter and 18 cm in height) filled with Promix BX (available from Premier Horticulture Inc. Quakertown, Pa.). Grass was irrigated daily by an overhead irrigation system. The irrigation system was set up with multiple Tornado Mist Spray Heads (10 GPH at 40 PSI-Wetted diameter, NDS/Raindrip, Woodland Hills, Calif.). Spray heads were 1-meter apart from each other and 75 cm above grass canopy. Grass was cut with a scissor at 2.5 cm height and fertilizer (1 g/L all purpose fertilizer 20-20-20, available from The Scotts Company, Marysville, Ohio) was applied once per week.

Field studies were conducted at the nursery green or the practice green at Countryside golf course (Mundelein, Ill.). Both greens were sand based and growing Penncross creeping bentgrass. Grass was managed with typical Illinois golf course management practices.

Chemical solutions were prepared with distilled water. Tween 20 (0.05% v/v) was used as the surfactant when necessary. Trinexapac-ethyl (commercial product Primo Maxx, 11.3% active ingredient) was purchased from Syngenta Crop Protection Inc. (Greensboro, N.C.). ABA analogs, 8′ acetylene-ABA, acid (PBI-524), 8′ acetylene-ABA, ester (PBI-429), 8′ cyclopropane ester (PBI-696), or Tetralone, first carbon tail acetylene, ester (PBI-702), were obtained from Plant Biotechnology Institute, National Research Council of Canada (Saskatoon, Saskatchewan, Canada).

Chemical solutions were foliar applied to the turfgrass canopy at the rate of 4-gallons/1000 square foot (or 0.163 L/m⁻²) immediately after finishing the preparation of solutions. After treatment, turfgrasses were arranged in a randomized complete block experimental design. Turfgrass quality, turfgrass height or clip fresh weight was measured on assigned dates. Turfgrass quality was visually rated on a 0-9 scale based on the color, uniformity, and density of the grass with 0 as the worst and 9 as the best. Turfgrass height was measured as the distance between canopy surface and soil. Clippings were collected form each plot; all plots were cut to a uniform height.

All experiments were randomized complete block experimental design. Data were analyzed by analysis of variance. Duncan's new multiple range tests at α=0.05 were used for mean separations.

### Example 1

Kentucky bluegrass sod was purchased from Deak sod farms, Inc. (Union Grove, Wis.). Grass was grown in the greenhouse for 94 days for establishment. Turfgrass was treated with one time foliar application of 50 ppm PBI-524, PBI-429, PBI-696 or PBI-702 alone or in combination with 250 ppm trinexapac-ethyl. The turfgrass was cut every 7 days. Turfgrass quality, turfgrass height, and clip weight were measured on days 7 and 35 after treatment.

Trinexapac-ethyl (250 ppm), PBI-524 (50 ppm), PBI-429 (50 ppm) and combinations of trinexapac-ethyl with either PBI-524 or PBI-429 reduced turfgrass height and clip weight compared to the control at 7 days after treatment (Table 1). This early effect of combining trinexapac-ethyl and either PBI-524 or PBI-429 was additive. However, surprisingly, at 35 days after treatment, PBI-524 or PBI-429 no longer reduced turfgrass height and clip weight, but the combinations of trinexapac-ethyl with either PBI-524 or PBI-429 remained more effective than trinexapac-ethyl alone. This later effect of combining trinexapac-ethyl and either PBI-524 or PBI-429 is synergistic.

TABLE 1
Effect of ABA analogs, trinexapac-ethyl, and their combinations
on turfgrass quality and growth of Kentucky bluegrass.

| | | | | | Turfgrass |
|---|---|---|---|---|---|
| | Turfgrass height (cm) | | Clip Weight (g) | | quality 7 |
| | 7 days after | 35 days after | 7 days after | 35 days after | days after |
| Treatment | treatment | treatment | treatment | treatment | treatment |
| Control | 7.7 | 8.2 | 1.4 | 2.1 | 7.0 |
| 250 ppm trinexapac-ethyl | 6.0 | 7.2 | 0.5 | 1.7 | 6.6 |
| 50 ppm PBI-524 | 5.8 | 8.0 | 0.5 | 1.9 | 6.6 |
| 50 ppm PBI-524 + 250 ppm | 5.0 | 6.3 | 0.3 | 1.6 | 6.1 |
| trinexapac-ethyl | | | | | |
| 50 ppm PBI-429 | 5.8 | 8.1 | 0.4 | 2.3 | 6.6 |
| 50 ppm PBI-429 + 250 ppm | 5.4 | 6.6 | 0.4 | 1.2 | 6.4 |
| trinexapac-ethyl | | | | | |

### Example 2

Trinexapac-ethyl (25 ppm) or PBI-429 (50 ppm) were one time foliar applied alone or in combination to creeping bentgrass in the golf course green to investigate their effect on turfgrass quality, growth inhibition and soil moisture.

At 4 days after treatment, trinexapac-ethyl did not reduce creeping bentgrass height. PBI-429 (50 ppm) reduced turfgrass height more than the combination of trinexapac-ethyl and PBI-429 (Table 2). This suggests that trinexapac-ethyl reduced the efficacy of PBI-429. At 7 days after treatment, trinexapac-ethyl and PBI-429 reduced turfgrass height similarly and the combination of trinexapac-ethyl and PBI-429 was more effective than either component alone. At 38 days after treatment, trinexapac-ethyl was again no longer effective. However, the combination of trinexapac-ethyl and PBI-429 was more effective than either component alone, suggesting a synergistic activity shown in Example 1 on Kentucky bluegrass.

Soil moisture shows a similar pattern of activity. At 4 days after treatment, PBI-429 alone or in combination with trinexapac-ethyl increase soil moisture, but trinexapac-ethyl does not. At 7 days after treatment, trinexapac-ethyl, PBI-429, and their combination increase soil moisture. At 38 days after treatment, trinexapac-ethyl is no longer effective, but the combination of trinexapac-ethyl and PBI-429 was more effective than either component alone, again suggesting a synergistic activity (Table 2).

Turf quality was not substantially affected by treatment at 7 or 38 days after treatment (Table 2).

Taken together, these results suggest that combination of the gibberellin synthesis inhibitor trinexapac-ethyl and the ABA analog PBI-429 would be surprisingly more effective over an extended period at reducing growth and maintaining soil moisture of turfgrass such as creeping bentgrass than either component alone.

TABLE 2
Effect of the ABA analog PBI-429, trinexapac-ethyl, and their combination on quality
and growth of creeping bentgrass and soil moisture of golf course green.

| | Turfgrass height (mm) | | | Soil moisture (%) | | | Turf quality | |
|---|---|---|---|---|---|---|---|---|
| | 4 days | 7 days | 38 days | 4 days | 7 days | 38 days | 7 days | 38 days |
| | after | after | after | after | after | after | after | after |
| | treatment | treatment | treatment | treatment | treatment | treatment | treatment | treatment |
| Control | 7.3 | 8.2 | 6.0 | 11.2 | 11.0 | 12.4 | 7.4 | 7.5 |
| 25 ppm | 7.3 | 6.5 | 6.0 | 11.2 | 12.7 | 12.4 | 7.3 | 7.6 |
| trinexapac- | | | | | | | | |
| ethyl | | | | | | | | |
| 50 ppm PBI-429 | 6.7 | 6.3 | 5.5 | 13.3 | 13.1 | 12.9 | 7.1 | 8.0 |
| 25 ppm | 6.8 | 5.6 | 4.4 | 13.2 | 13.4 | 13.4 | 6.8 | 7.9 |
| trinexapac- | | | | | | | | |
| ethyl + 50 | | | | | | | | |
| ppm PBI-429 | | | | | | | | |

### Example 3

Trinexapac-ethyl (25 ppm) or PBI-702 (50 ppm) were one time foliar applied alone or in combination to creeping bentgrass in the golf course green to investigate their effect on turfgrass quality, growth inhibition and soil moisture.

At 4 days after treatment, trinexapac-ethyl was ineffective at reducing growth or maintaining soil moisture (Table 3). However, PBI-702 in combination with trinexapac-ethyl was more effective than trinexapac-ethyl alone at reducing growth or maintaining soil moisture. At 7 days after treatment, trinexapac-ethyl, PBI-702 and their combination were effective at reducing growth. However, PBI-702 in combination with trinexapac-ethyl was again more effective than trinexapac-ethyl alone at reducing growth or maintaining soil moisture. By 38 days after treatment, the combination remained more effective than either treatment alone, but there were no treatment differences for soil moisture. Turf quality was not affected by treatment at 7 or 38 days.

TABLE 3
Effect of ABA analogs, Trinexapac-ethyl, and their combination on quality
and growth of creeping bentgrass and soil moisture of golf course green.

| | Turfgrass height (mm) | | | Soil moisture (%) | | | Turf quality | |
|---|---|---|---|---|---|---|---|---|
| | 4 days | 7 days | 38 days | 4 days | 7 days | 38 days | 7 days | 38 days |
| | after | after | after | after | after | after | after | after |
| | treatment | treatment | treatment | treatment | treatment | treatment | treatment | treatment |
| Control | 7.3 | 8.2 | 6.0 | 11.2 | 11.0 | 12.4 | 7.4 | 7.5 |
| 25 ppm | 7.3 | 6.5 | 6.0 | 11.2 | 12.7 | 12.4 | 7.3 | 7.6 |
| trinexapac- | | | | | | | | |
| ethyl | | | | | | | | |
| 50 ppm PBI-702 | 6.7 | 6.5 | 5.5 | 12.3 | 11.5 | 12.4 | 7.3 | 7.6 |
| 25 ppm | 6.7 | 6.2 | 5.3 | 13.2 | 13.2 | 12.5 | 7.4 | 7.5 |
| trinexapac- | | | | | | | | |
| ethyl + 50 | | | | | | | | |
| ppm PBI-702 | | | | | | | | |

### Example 4

Trinexapac-ethyl (25 ppm) and PBI-696 (5 or 50 ppm) were one time foliar applied in combination to creeping bentgrass in the golf course green. Turfgrass quality and growth rate were measured 4 days after treatment.

Compared to the trinexapac-ethyl control, growth rate was reduced when 5 or 50 ppm PBI-696 was applied with trinexapac-ethyl (Table 4). Turfgrass quality was slightly less for the combination treatment of 50 ppm PBI-696 and trinexapac-ethyl.

TABLE 4
Comparison between trinexapac-ethyl alone and its combination
with ABA or ABA analogs on turfgrass quality or growth rate.

| | 4 days after treatment | |
|---|---|---|
| | Growth rate (mg dry | Turfgrass |
| Treatment | weight m⁻² day⁻¹) | quality |
| Trinexapac-ethyl | 549 | 8.0 |
| 5 ppm PBI-696 + trinexapac-ethyl | 517 | 8.0 |
| 50 ppm PBI-696 + trinexapac-ethyl | 436 | 7.3 |

### Example 5

The effect of ABA analog (PBI-429) and trinexapac-ethyl combinations on transpiration and growth inhibition of dicotyledonous (tomato) was also examined in the greenhouse condition. Tomato (variety: Rutgers) seeds were sown in 18-cell flat filled with Promix PGX (available from Premier Horticulture Inc. Quakertown, Pa.) and grown for 3 weeks to allow for germination and initial growth. Plants were then transplanted into pots (18 cm in diameter and 18 cm in height), filled with Promix BX (available from Premier Horticulture Inc. Quakertown, Pa.), and grown for one week before the chemical treatment. Plants received daily irrigation and weekly fertilizer (1 g/L all purpose fertilizer 20-20-20, available from The Scotts Company, Marysville, Ohio).

During the chemical treatment, a 24 mL (4 mL/plant) solution was foliar sprayed on the tomato canopy. Leaf transpiration rates were measured using a LI-1600 Steady State Porometer (LI-Cor, Lincoln, Nebr.) at 3, 5, 7, 10, and 14 days after treatment. The leaf transpiration rate was normalized to the percentage of control plant to minimize the experimental errors caused by environmental factors. Plant height was measured at 0, 3, 5, 7, 10 and 14 days after treatment. The growth rate was calculated based on the changes of plant height in certain intervals. The plants were harvested and the leaf number was counted at 14 days after treatment.

ABA analog PBI-429 inhibited tomato leaf transpiration (Table 5). The extent and longevity of transpiration inhibition increased with the increase of PBI-429 concentrations. Trinexapac-ethyl alone did not significantly inhibited tomato leaf transpiration. The combination of PBI-429 and trinexapac-ethyl provided addition transpiration inhibition at the same date after treatment compared to PBI-429 alone. The combination of PBI-429 and trinexapac-ethyl also extended transpiration inhibition compared to PBI-429 alone at the same rate.

TABLE 5
Effect of ABA analog (PBI-429), trinexapac-ethyl, and their
combinations on tomato leaf transpiration inhibition.

| | Transpiration (% of control) | | | | |
|---|---|---|---|---|---|
| | Days after treatment | | | | |
| Treatment | 3 | 5 | 7 | 10 | 14 |
| Control | 100 | 100 | 100 | 100 | 100 |
| 25 ppm PBI-429 | 53 | 61 | 75 | 80 | 103 |
| 50 ppm PBI-429 | 36 | 32 | 42 | 69 | 99 |
| 100 ppm PBI-429 | 34 | 29 | 38 | 55 | 98 |
| 200 ppm PBI-429 | 26 | 24 | 28 | 34 | 71 |
| 250 ppm trinexapac-ethyl | 95 | 95 | 94 | 94 | 100 |
| 500 ppm trinexapac-ethyl | 94 | 101 | 94 | 97 | 97 |
| 1000 ppm trinexapac-ethyl | 100 | 95 | 94 | 101 | 100 |
| 2000 ppm trinexapac-ethyl | 94 | 96 | 93 | 91 | 96 |
| 25 ppm PBI-429 + 250 ppm trinexapac-ethyl | 45 | 55 | 62 | 71 | 93 |
| 50 ppm PBI-429 + 500 ppm trinexapac-ethyl | 30 | 33 | 38 | 47 | 85 |
| 100 ppm PBI-429 + 1000 ppm trinexapac-ethyl | 29 | 22 | 25 | 41 | 75 |
| 200 ppm PBI-429 + 2000 ppm trinexapac-ethyl | 26 | 19 | 19 | 26 | 47 |

PBI-429 decreased tomato plant height (Table 6). This reduction of plant height increased with the increase of PBI-429 concentrations. The reduction also lasted longer for high concentration PBI-429 than low concentration PBI-429. Trinexapac-ethyl also decreased tomato plant height in the similar rate-dependent manner as PBI-429. The combination of PBI-429 and trinexapac-ethyl further decreased plant height compared to PBI-429 or trinexapac-ethyl alone at the same rate.

TABLE 6
Effect of ABA analog (PBI-429), trinexapac-ethyl
and their combinations on tomato plant height.

| | Plant height (cm) | | | | | |
|---|---|---|---|---|---|---|
| | Days after treatment | | | | | |
| Treatment | 0 | 3 | 5 | 7 | 10 | 14 |
| Control | 6.2 | 10.5 | 13.2 | 16.3 | 20.8 | 26.4 |
| 25 ppm PBI-429 | 6.3 | 8.6 | 10.4 | 12.8 | 16.0 | 20.7 |
| 50 ppm PBI-429 | 6.3 | 8.8 | 10.0 | 11.6 | 13.9 | 18.2 |
| 100 ppm PBI-429 | 6.3 | 8.4 | 9.4 | 10.8 | 12.8 | 16.2 |
| 200 ppm PBI-429 | 6.4 | 7.9 | 8.7 | 9.6 | 10.9 | 13.8 |
| 250 ppm trinexapac-ethyl | 6.4 | 9.9 | 11.9 | 15.1 | 19.6 | 26.9 |
| 500 ppm trinexapac-ethyl | 6.5 | 9.3 | 10.9 | 13.3 | 17.4 | 24.4 |
| 1000 ppm trinexapac-ethyl | 6.5 | 8.9 | 10.3 | 12.3 | 15.8 | 22.8 |
| 2000 ppm trinexapac-ethyl | 6.7 | 7.9 | 9.1 | 10.7 | 13.6 | 18.3 |
| 25 ppm PBI-429 + 250 ppm trinexapac-ethyl | 6.8 | 8.4 | 9.8 | 11.8 | 15.1 | 19.0 |
| 50 ppm PBI-429 + 500 ppm trinexapac-ethyl | 6.8 | 7.5 | 8.7 | 9.9 | 11.9 | 14.8 |
| 100 ppm PBI-429 + 1000 ppm trinexapac- | 6.9 | 7.1 | 7.7 | 8.3 | 9.7 | 11.8 |
| ethyl | | | | | | |
| 200 ppm PBI-429 + 2000 ppm trinexapac- | 7.1 | 6.7 | 6.9 | 7.3 | 8.1 | 9.5 |
| ethyl | | | | | | |

PBI-429 decreased tomato growth rate in terms of plant height during the experimental periods (Table 7). The reduction was more for high concentrations of PBI-429 than low concentrations. Trinexapac-ethyl also inhibited growth rate. High concentration trinexapac-ethyl inhibited more growth rate. The inhibition in growth rate lasted longer for high concentration trinexapac-ethyl. The combination of PBI-429 and trinexapac-ethyl reduced growth rate more than PBI-429 or trinexapac-ethyl alone at same rate.

TABLE 7
Effect of ABA analog (PBI-429), trinexapac-ethyl,
and their combinations on tomato growth rate.

| | Growth rate (cm day⁻¹) | | | | |
|---|---|---|---|---|---|
| | Days after treatment | | | | |
| Treatment | 3 | 5 | 7 | 10 | 14 |
| Control | 1.4 | 1.3 | 1.6 | 1.5 | 1.4 |
| 25 ppm PBI-429 | 0.8 | 0.9 | 1.2 | 1.1 | 1.2 |
| 50 ppm PBI-429 | 0.6 | 0.6 | 0.8 | 0.8 | 1.1 |
| 100 ppm PBI-429 | 0.6 | 0.5 | 0.7 | 0.7 | 0.9 |
| 200 ppm PBI-429 | 0.5 | 0.4 | 0.5 | 0.4 | 0.7 |
| 250 ppm trinexapac-ethyl | 1.2 | 1.0 | 1.6 | 1.5 | 1.8 |
| 500 ppm trinexapac-ethyl | 0.9 | 0.8 | 1.2 | 1.4 | 1.8 |
| 1000 ppm trinexapac-ethyl | 0.7 | 0.7 | 1.0 | 1.2 | 1.8 |
| 2000 ppm trinexapac-ethyl | 0.6 | 0.6 | 0.8 | 1.0 | 1.2 |
| 25 ppm PBI-429 + 250 ppm trinexapac-ethyl | 0.4 | 0.7 | 1.0 | 1.1 | 1.0 |
| 50 ppm PBI-429 + 500 ppm trinexapac-ethyl | 0.4 | 0.6 | 0.6 | 0.7 | 0.7 |
| 100 ppm PBI-429 + 1000 ppm trinexapac-ethyl | 0.2 | 0.3 | 0.3 | 0.4 | 0.5 |
| 200 ppm PBI-429 + 2000 ppm trinexapac-ethyl | 0.1 | 0.1 | 0.2 | 0.3 | 0.4 |

PBI-429 only significantly reduced leaf number at the highest rate (200 ppm, Table 8). Trinexapac-ethyl did not change the tomato leaf number. The combination of PBI-429 and trinexapac-ethyl decreased leaf number except the lowest concentration

TABLE 8
Effect of ABA analog (PBI-429), trinexapac-ethyl,
and their combinations on tomato leaf number

| | Leaf number |
|---|---|
| Treatment | 14 Days after treatment |
| Control | 11.0 |
| 25 ppm PBI-429 | 11.0 |
| 50 ppm PBI-429 | 11.0 |
| 100 ppm PBI-429 | 10.8 |
| 200 ppm PBI-429 | 10.5 |
| 250 ppm trinexapac-ethyl | 11.0 |
| 500 ppm trinexapac-ethyl | 11.0 |
| 1000 ppm trinexapac-ethyl | 11.0 |
| 2000 ppm trinexapac-ethyl | 10.8 |
| 25 ppm PBI-429 + 250 ppm trinexapac-ethyl | 10.7 |
| 50 ppm PBI-429 + 500 ppm trinexapac-ethyl | 10.5 |
| 100 ppm PBI-429 + 1000 ppm trinexapac-ethyl | 10.2 |
| 200 ppm PBI-429 + 2000 ppm trinexapac-ethyl | 9.5 |

1. A method of accelerating and extending the growth inhibitory effect of gibberellin synthesis inhibitors that comprises applying an effective amount of an abscisic acid (ABA) analog, derivative or salt thereof.

2. The method of claim 1 wherein the gibberellin synthesis inhibitor is trinexapac-ethyl.

3. The method of claim 2 wherein the gibberellin synthesis inhibitor/ABA analog or derivative combination is applied to turfgrass.

4. The method of claim 2 wherein the abscisic acid analog is 8′ acetylene-ABA, acid.

5. The method of claim 2 wherein the abscisic acid analog is 8′ acetylene-ABA, ester.

6. The method of claim 2 wherein the abscisic acid analog is 8′ cyclopropane-ABA ester.

7. A method of improving the reduction in soil moisture caused by gibberellin synthesis inhibitors that comprises applying an effective amount of an abscisic acid (ABA) analog, or derivative or thereof.

8. The method of claim 1 wherein the gibberellin synthesis inhibitor/ABA derivative or analog combination is applied to dicotyledonous plants.
